(19) United States
(12) Patent Application Publication
(10) Pub. No.: US 2007/0057970 A1
(43) Pub. Date: Mar. 15, 2007

(54) Multi-function display module for mobile stations

(75) Inventor: Marcel Vasilache, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/227,641

(22) Filed: Sep. 14, 2005

(51) Int. Cl. G09G 5/00

(52) U.S. Cl. 345/629

(57) ABSTRACT

A mobile station including an illumination section for emitting light, a display section upon which an image can be formed and through which light can pass, and a display controller for controlling the image wherein the display section, in a first position, is generally parallel to and at least partially overlaps the illumination section and wherein the display section, in a second position, is separated from the illumination section into a non-overlapping position.

### TECHNICAL FIELD

This invention relates generally to user interfaces and, more specifically, to user interface display apparatus

### BACKGROUND

It is known in the art to connect a laptop computer, or other computing device, to a projector so as to project images. Typical uses of such technology include giving PowerPoint™ presentations. In such scenarios, a signal is typically outputted from the computing device to the projector. The signal may be formed of an analog signal, such as that that might be otherwise sent to a display monitor, or digital data.

With the proliferation of mobile stations, it is not uncommon to use a mobile platform, such as a mobile phone, to store digital data for retrieval and manipulation. In response to this reality, technologies have been developed to enable the projection of images and data stored on a mobile platform. For example, U.S. patent application Ser. No. 10/122,496, published Feb. 13, 2003, discloses a mobile station having a built-in projector.

U.S. patent application Ser. No. 10/234,515, published Mar. 11, 2004, discloses connecting a mobile station to an external screen via Bluetooth. Such an arrangement requires a screen on which to view the output of the mobile station that is outfitted, or otherwise configured, to receive wireless communications from the mobile station. This requirement lessens the likelihood that any given location wherein one wishes to utilize such an arrangement will have available a suitably configured screen. In addition, carrying such a screen around is inconvenient.

As mobile stations, in particular mobile phones, continue to proliferate, there exists a need for an arrangement whereby the mobile station can serve as a progenitor of information to be projected. Preferably, it would not require expensive or exotic components to achieve the projection.

### SUMMARY OF THE PREFERRED EMBODIMENTS

In accordance with an exemplary embodiment of the invention a mobile station includes an illumination section for emitting a light, a display section upon which an image can be formed and through which light can pass, and a display controller for controlling the image wherein the display section, in a first position, is generally parallel to and at least partially overlaps the illumination section and wherein the display section, in a second position, is separated from the illumination section into a non-overlapping position.

In an alternative exemplary embodiment of the invention, an apparatus comprises a projector comprising a light source and a lens, and a mobile station having a display section upon which an image is formed and an illumination section, the display section being generally parallel to and at least partially overlapping the illumination section in a first position and the display section being displaced from the illumination section into a non-overlapping position in a second position, wherein in the second position, the display section is situated between the light source and the lens to project the image.

In an alternative exemplary embodiment of the invention, a method for projecting an image from a mobile station comprises forming an image upon a display section through which light can pass coupled to the mobile station, inserting a portion of the display section into a projector comprising a light source, and emitting a light from the light source through the display section to project the image.

### BRIEF DESCRIPTION OF THE DRAWINGS

The foregoing and other aspects of these teachings are made more evident in the following Detailed Description, when read in conjunction with the attached Drawing Figures, wherein:

FIG. 1. is an illustration in cross section of an LCD display structure known in the art.

FIG. 2. is an illustration in cross section of an LCD display section separated from an illumination section according to the invention.

FIG. 3. is an illustration of a mobile station with an LCD display section in a first, or closed, position.

FIG. 4 is an illustration of a mobile station with an LCD display section in a second, or open, position.

FIG. 5 is a perspective illustration of a mobile station in an open position.

FIG. 6 is an illustration of an image on a display wherein the image is superimposed over a target.

FIG. 7 is a diagram showing the coupling of a mobile station and a projector.

FIG. 8 is an illustration in cross section of an exemplary embodiment of a mobile station according to the invention.

### DETAILED DESCRIPTION

In an exemplary embodiment of the present invention, there is provided a mobile station formed of a backlit display, typically a liquid crystal display (LCD), whereby the display is configured for insertion into a projector for projecting the display. In an exemplary embodiment, the portion of the display that provides the backlighting is separable from an LCD layer that displays data. As a result, the LCD layer can be inserted into a projector through which the projector can provide sufficiently powerful illumination so as to project an image formed on the LCD layer. While illustrated and described herein with reference to an LCD display incorporated into a mobile station, the invention is drawn broadly to encompass any and all display technologies capable of producing an image, especially those through which light may pass, coupled to, or otherwise incorporated in, a mobile station. Examples of mobile stations include, but are not limited to, mobile radio telephones, personal digital assistants (PDAs), as well as dedicated digital data devices for use with a projector as described more fully below.

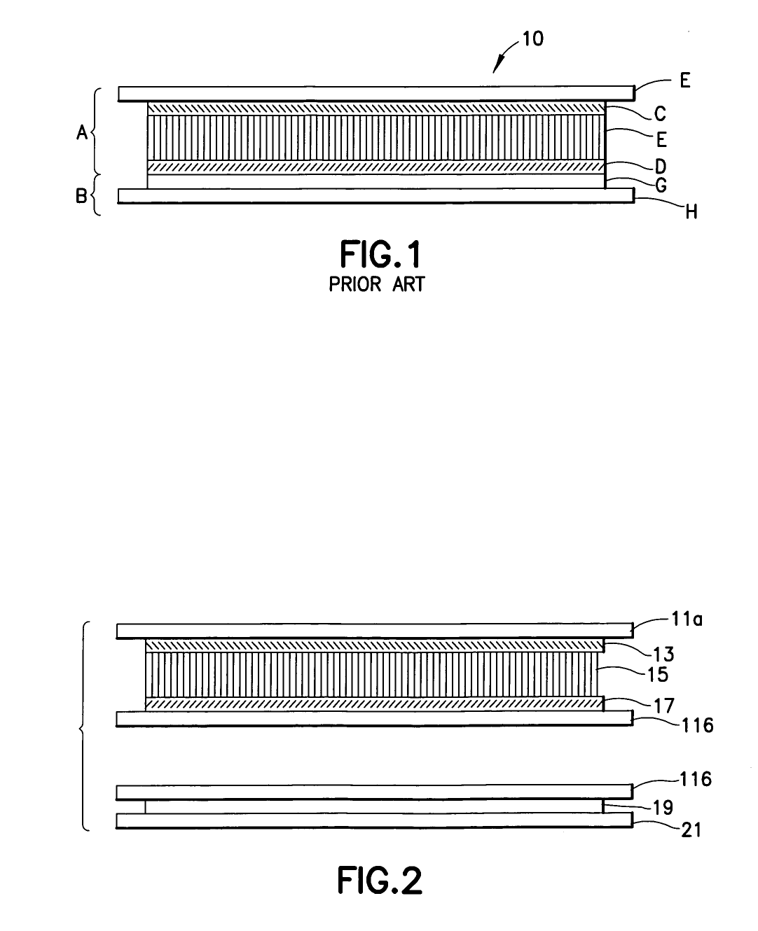

With reference to FIG. 1, there is illustrated in side view a typical LCD display structure 10 known in the art. The LCD display structure 10 is formed, generally, of LCD display section A and illumination section B. Both LCD display section A and illumination section B are formed of generally planar components as described more fully below. As a result, both display section A and illumination section B are generally planar in construction. LCD display section A is formed of a top polarization layer C and a bottom polarization layer D between which is interposed, or sandwiched, a liquid crystal layer E. Liquid crystal layer E is typically formed of a glass substrate into which is integrated a multitude of color filters and liquid crystals for displaying data. A transparent protective layer F is routinely provided to completely, or substantially, cover the outward facing expanse of top polarization layer C. Transparent protective layer F operates to provide a barrier preventing possibly damaging external contact to the top polarization layer C. Preferably, protective layer F, top polarization layer C, liquid crystal layer E and bottom polarization layer D are arranged one atop the other and sandwiched such that there is no appreciable space between successive layers.

Extending generally across the expanse of the bottom polarization layer D is a background lighting layer G. Background lighting layer G may be formed of any material capable of emitting light. Typically, such layers are formed of electroluminescent foil. Background lighting layer G is mated on a side in opposition to the bottom polarizing layer D to a support H. Together, background lighting layer G and support H form illumination section B. Support H provides structural integrity to illumination section B.

With reference to FIG. 2, in accordance with an exemplary embodiment of the invention, there is illustrated an LCD display structure wherein the LCD display section 25 is separated from the illumination section 23. When separated, an additional transparent protective layer 11b is preferably mated to a surface of polarization layer 17 of LCD display section 25. Similarly, an additional transparent protective layer 11b is coupled to a side of the background lighting layer 19 not in contact with support 21. As a result, both LCD display section 25 and illumination section 23 form separate and separable entities capable of functioning together when placed in contact with or in close proximity to each other but with sufficient structural integrity and support to operate separately. Generally, structural integrity for the LCD display section 25 is provided by one or both protective layers 11a, 11b being rigid.

With reference to FIG. 3, there is illustrated an exemplary embodiment of the invention wherein an LCD display section 25 and an illumination section 23 are integrated into a mobile station 30 and configured in a first position. In this non-limiting example, mobile station 30 is a mobile phone. Illumination layer 23 is preferably recessed into mobile station 30 in an orientation generally parallel to a generally planar outer surface 31 of mobile station 30. As used herein, use of the terms “generally planar” and “generally parallel” denote expanses which are planar but for the presence of unintended irregularities and the orientation of two or more elements which are situated in corresponding parallel orientations but for unintended deviations respectively. Such a placement of illumination section 23 allows for the placement of an LCD display section 25 generally parallel to and largely covering illumination section 23. While illustrated as separated by a small distance, illumination section 23 and LCD display section 25 may reside in contact with each other. It is desirable that illumination section 23 be in close enough proximity to LCD display section 25 so as to permit light generated by illumination section 23 to pass through LCD display section 25 in an amount sufficient to permit viewing of a display formed on LCD display section 25. Preferably, when oriented generally parallel to illumination section 23, a side of LCD display section 25 facing away from illumination section 23 is generally flush with the outer surface 31 of mobile station 31.

It is understood that the liquid crystal layer 15 of display section 25 may be controlled, typically by the application of discrete voltages to individual color filters and liquid crystals, creating a display formed of picture elements, or pixels. Control of the pixels forming the display is performed by a processor 33. Processor 33 is any processing device capable of receiving input data, manipulating such data through the application of machine readable program code, and outputting a signal, preferably a digital signal, for controlling the display formed on LCD display device 25. Processor 33 is coupled to LCD display section 25 via a hardwire connection 35.

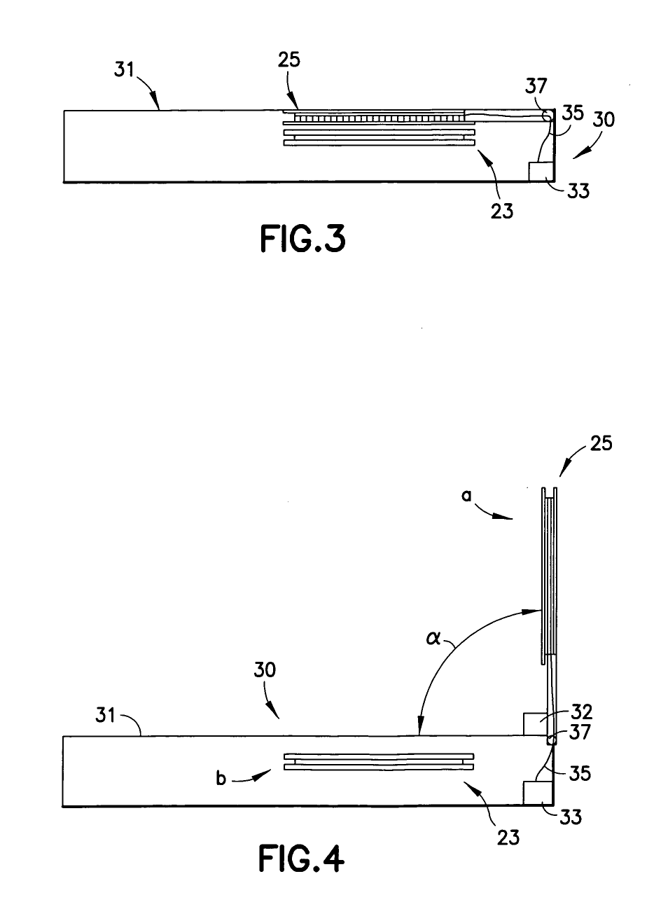

With reference to FIG. 4, there is illustrated an exemplary embodiment whereby LCD display section 25 may be separated from illumination section 23 into a second position. In the example shown, LCD display section 25 is configured to achieve radial displacement from the first position through an angle α about a pivot point 37. While appearing as a point when viewed in profile, pivot point 37 is typically a hinge or the like spanning a linear distance and forming an axis about which LCD display section 25 can pivot. While it is possible to separate LCD display section 25 from the illumination section 23 in a variety of ways, such as through a rotational or linear displacement, radial pivoting about the pivot point 37 provides for a separation wherein the orientation of LCD display section 25 may be controlled and which further provides for a structural pathway through which hardwire connection 35 may be positioned. Once displaced, additional structural integrity can be supplied through the use of a locking mechanism 32 utilized to maintain an orientation of the LCD display section in relation to the illumination section 23. Locking mechanism 32 may be any physical element configured to provide further structural integrity to LCD display section 25.

With reference to FIG. 5, there is illustrated a perspective view of LCD display section 25 angularly displaced from illumination section 23 in an exemplary embodiment of a mobile station 30. Mobile station 30 is generally formed of a processor 33 coupled to a memory 52, a user interface 85, and the LCD display section 25. The memory 52 is capable of storing and retrieving any and all forms of digital data and communicating such data to the processor 33. As described more fully below, user interface 85 may include, but is not limited to, a keyboard or keypad and serves to input data to the processor 33.

In the configuration illustrated, the display 51 created on LCD display section 25 by processor 33 is visible as a result of ambient light passing through LCD display section 25. Note that under such conditions, display 51 can be viewed from either opposing side of the plane formed by LCD display section 25. When viewed from opposing sides, display 51 appears as two different representations of the same image each of which is a mirror image of the other. Depending upon the preferred orientation of a user wishing to view a display 51 in the instance that LCD display section 25 has been rotated to the second position, it may be desirable for the processor 33 to rotate, reverse, translate, or otherwise manipulate the image displayed as display 51 so as to render the image in an appropriate orientation.

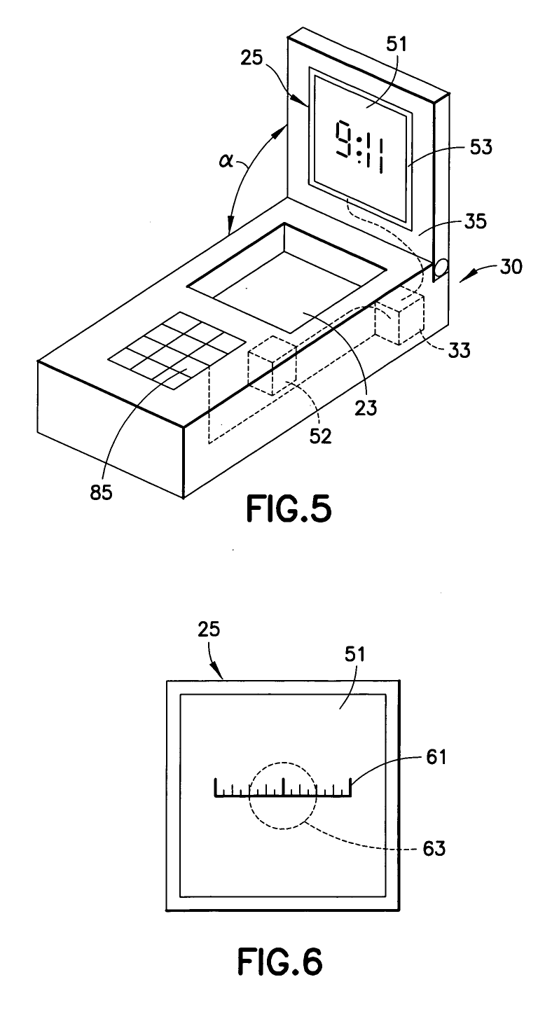

With reference to FIG. 6, there is illustrated an exemplary embodiment of LCD display section 25 wherein the display 51 is formed of an image 61. Visible through LCD display section 25 is a target 63. The target 63 may be any object external to mobile station 30. In the example illustrated, image 61 is that of a calibration element, such as a measurement grid. The image 61 may be formatted and scaled to a desirable configuration by processor 33. When LCD display section 25 is placed in proximity to, preferably flush with, the target 63, image 61 is seen to be superimposed over target 63. As a result, a measurement of the target 63 may be performed. While illustrated with reference to an image 61 used for measurement of an attribute of target 63, image 61 may be any image 61 capable of being overlaid, or superimposed, on a target 63. For example, image 61 could be an area of color such that when placed against or near a target 63, such as a painted wall, a determination of the color of the wall can be made through a process of performing a visual comparison the image 61 to the target 63. Note also that, in this exemplary embodiment, a structural border is provided about the periphery of the LCD display section 25 to lend structural support to the LCD display section 25.

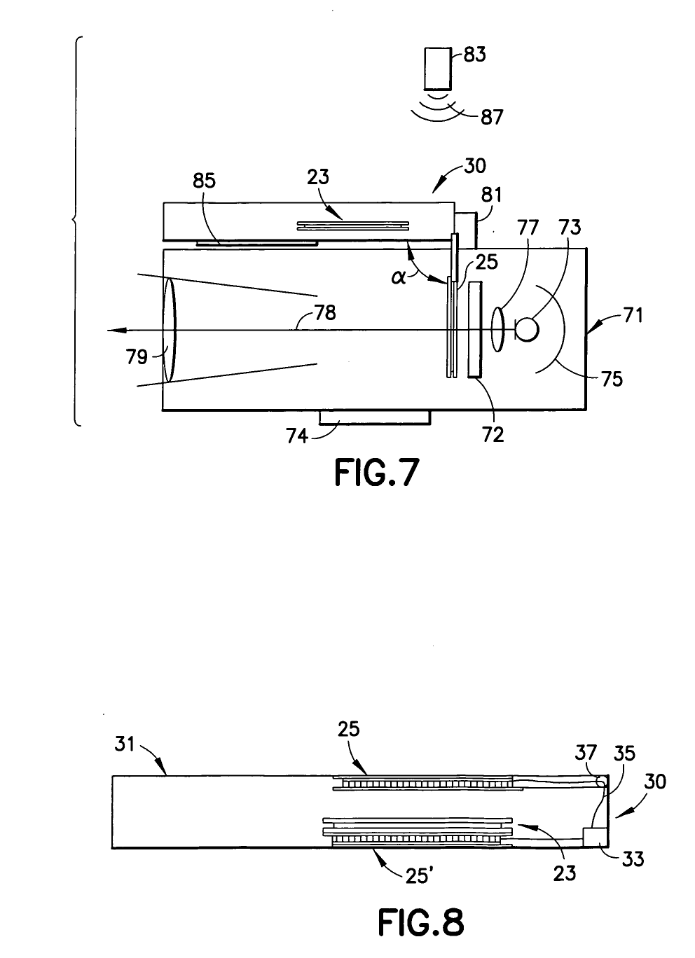

With reference to FIG. 7, there is illustrated another exemplary embodiment of the invention. Mobile station 30 is in a second position wherein the LCD display section 25 is rotationally displaced by approximately ninety degrees from illumination section 23. LCD display section 25 is inserted into an interior portion of a projector 71. Projector 71 is formed of optics and other elements, described more fully below, to project the image 61 onto a surface exterior to projector 71.

Projector 71 is formed, at a minimum, of a light source 73 and a lens 79 arranged along an optical pathway 78. When LCD display section 25 is placed between light source 73 and lens 79, light emitted from light source 73 passes through LCD display section 25 so as to project the image 61 on LCD display section 25 through lens 79 and away from projector 71. Manipulation of lens 79 permits focusing of image 61 on a desired surface (not shown).

In addition to light source 73 and lens 79, projector 71 is preferably formed of a heat shield 72 interposed between light source 73 and LCD display section 25. Heat shield 72 forms a transparent, or largely transparent, barrier preventing the transmission of heat energy from light source 73 to LCD display section 25 in an amount sufficient to damage LCD display section 25. A condenser lens 77 is optionally provided to focus the light emitted from light source 73 onto LCD display section 25. In addition, a mirror 75 may be positioned to direct light from the light source 73 emitted away from LCD display section 25 back towards LCD display section 25.

In an alternative embodiment, illumination section 23 may remain coupled, or in close proximity to, LCD display section 25 as when, for example, both layers 23, 25 are radially displaced together. In such an instance, both layers 23, 25 are inserted into projector 71 for projecting the image 61. Such an arrangement requires illumination section 23 to be substantially transparent to a degree which allows sufficient light from light source 73 to pass through it.

Mobile station 30 may be interfaced to projector 71 for the communication of data between the two of data. Such an interface may be accomplished through coupling 81. Coupling 81 can be a hardwire connection or a wireless connection, such as that provided by Bluetooth. Such a coupling enables the transmission of control data from mobile station 30 to projector 71. Such control data may include, but is not limited to, light source 73 intensity, focus and zoom control, and the like. Control data may be inputted to mobile station 30 via a user interface 85, such as a keypad, coupled to said mobile station. In instances where the LCD display section is radially displaced by approximately two hundred and seventy degrees, keypad 85 can be oriented to face outwards away from the projector 71. In an alternative embodiment, the operation of the projector 71 may be controlled by one or more projector controls 74 coupled to the projector 71. Examples of projector controls 74 include, but are not limited to, a keyboard, a mouse, and a voice control system incorporating speech detection and command recognition software.

In addition, a remote control device 83 may be used to manipulate the image 61 created by the processor 33. Remote control device 83 can send instructions or other data to mobile station 30 via a connection 87, preferably a wireless connection. For example, display 51 may be formed of a series of images related to a presentation, such as a PowerPoint™ presentation. Remote control device 83 can be utilized to control the timing of the display of successive images 61. In an alternative exemplary embodiment, the images 61 displayed upon display 51 may be received by the mobile station 30 via a wireless link. Such images 61 may be received in real time and may include a series of images 61 forming a series of moving pictures such as are encoded in MPEG files.

While illustrated with reference to a single LCD display section 25 of a single mobile station 30 inserted into the projector 71, the invention is not so limited. Rather, the invention is drawn broadly to encompass the insertion of multiple LCD display sections 25 of multiple mobile stations 30 into a projector 71 for the projection of, at a minimum, stereo image pairs. Such stereo image pairs may be projected using a single LCD display layer 25 whereby the stereo image pairs are time domain separated.

In an alternative exemplary embodiment, a plurality of projected images can be tiled together to form a single projected image. In such an instance, the individual projections are aligned utilizing a software component present on each electronic device to manage proper image splitting and synchronisation for image updates. In such instances, the mobile electronic devices may support multiple device communication.

With reference to FIG. 8, there is illustrated a further exemplary embodiment of the invention. As illustrated, mobile station 30 includes a single illumination section 23. In close proximity thereto is located first and second LCD display sections 25, 25′. As configured, similar or different images 61 may be simultaneously displayed upon the LCD display sections 25, 25′. In addition, when LCD display section 25 is rotationally, or otherwise, displaced from illumination section 23, LCD display section 25′ may remain in close enough proximity to illumination section 23 such that light emitted from illumination section 23 renders an image 61 displayed upon LCD display section 25′ visible.

In general, the various embodiments of the mobile station 30 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention involving the creation of an image upon the LCD display section 25 may be implemented by computer software executable by a data processor of the mobile station 30, such as the processor 33, or by hardware, or by a combination of software and hardware.

The memory 52 may be of any type suitable to the local technical environment and may be implemented using any suitable data storage technology, such as semiconductor-based memory devices, magnetic memory devices and systems, optical memory devices and systems, fixed memory and removable memory. The data processor 33 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments such as orienting the display of images on the LCD display section and the images displayed thereupon, may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Certain embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

What is claimed is:

1. A portable electronic device comprising:
an illumination section for emitting light; and
a display section upon which an image is formed,
wherein said illumination and display sections are movably coupled such that, in a first position, they at least partially overlap one another and in a second position they are spaced from one another in a non-overlapping position.

2. The portable electronic device of claim 1 wherein said display section is generally planar and substantially transparent.

3. The portable electronic device of claim 1 wherein said illumination and display sections are rotationally coupled together.

4. The portable electronic device of claim 1 wherein in the first position the illumination section and the display section are generally parallel; and in the second position the illumination section and the display section are angularly offset from each other.

5. The portable electronic device of claim 1 further comprising means for transmitting control data for controlling a projection of said image when said illumination and display sections are in the second position.

6. The portable electronic device of claim 5 further comprising means for inputting at least some of the control data into said portable electronic device.

7. The portable electronic device of claim 6 wherein said means for inputting comprises manual input means.

8. The portable electronic device of claim 5 further comprising a wireless receiver for receiving said control data from a remote control device.

9. The portable electronic device of claim 1 comprising a mobile telephone.

10. The portable electronic device of claim 1 further comprising a locking mechanism for maintaining said sections in the second position.

11. A method for projecting an image comprising:
providing a display section of an electronic device;
arranging said display section within an optical path of a projector; and
emitting light along said optical path through said display section for projection for projecting an image displayed on said display section.

12. The method of claim 11, wherein the display section is separated from a light-emitting illumination section.

13. The method of claim 11, wherein the display section is essentially transparent.

14. The method of claim 11 further comprising transmitting control data to control said projector.

15. The method of claim 14 where arranging said display section within the optical part of the projector includes displacing the display section from a first position generally parallel to and at least partially overlapping an illumination section to a second position wherein the display section is separated from the illumination section into a non-overlapping position.

16. The method of claim 15 wherein displacing the display section comprises a linear displacement.

17. The method of claim 15 wherein displacing the display section comprises a rotational displacement.

18. The method of claim 15 wherein displacing the display section comprises a displacement through an angle α.

19. The method of claim 18 wherein the angle α comprises approximately 90 degrees.

20. The method of claim 18 wherein the angle α comprises approximately 270 degrees.

21. An image display section comprising:
a first transparent protective layer;
a second transparent protective layer;
a first polarization layer coupled to said first transparent protective layer;
a second polarization layer coupled to said second transparent protective layer; and
a liquid crystal layer arranged between and coupled to said first and second polarization layers,
such that said image display section is movably coupled to a light-emitting illumination section.

22. The image display section of claim 21 arranged in a first housing section of a mobile station, said mobile station comprising an illumination section particularly adapted to illuminate said display section; the illumination section being arranged in a second housing section of the mobile station movably coupled to the first housing section of the mobile station.

23. An apparatus comprising:
means for forming an image upon a transparent display section of a portable electronic device;
means for arranging said display section along an optical path of a projector; and
means for emitting light along said optical path through said display section for projecting said image of said display section.

24. The apparatus of claim 23 wherein said means for forming comprises a processor.
